(19) United States
(12) Patent Application Publication
(10) Pub. No.: US 2004/0205703 A1
(43) Pub. Date: Oct. 14, 2004

(54) Playing in scenarios of system behavior

(75) Inventors: David Harel, Jerusalem (IL); Rami Marelly, Rishon Le Zion (IL)

Correspondence Address: FITCH EVEN TABIN AND FLANNERY, 120 SOUTH LA SALLE STREET, SUITE 1600, CHICAGO, IL, 60603-3406, US

(73) Assignee: Yeda Research and Development Co . , Ltd. ,

(21) Appl. No.: 09/815,123

(22) Filed: Mar. 22, 2001

Related U.S. Application Data
(60) Provisional application No. 60/258,507, filed on Dec. 28, 2000.

(51) Int. Cl. G06F 9/44; G06G 7/48; G06G 7/62; G06F 17/50

(52) U.S. Cl. 717/109; 703/6; 703/13

(57) ABSTRACT

There is proposed a methodology for specifying the behavior of reactive systems, which is based on “Playing in” the system's possible scenarios. The use of this methodology is shown by building a practical “Play In Engine” tool based on the methodology. Users will be able to connect their Mock-Up GUI to the tool by “playing” their GUI and specifying the required system reactions in a simple and intuitive manner. As this is being done, the system will automatically generate behavior specifications in the language of Live Sequence Charts (LSCs), or any other suitable requirement language, such as various temporal logics or timing diagrams.

This application claims priority to U.S. Provisional Application No. 60/258,507, filed Dec. 28, 2000.

### FIELD AND BACKGROUND OF THE INVENTION

Object orientation has been the most dominant methodology for developing software systems in the last two decades. Object oriented modeling (OOAD—Object Oriented Analysis and Design) started to show up in the late 1980's and has been used to “lift” concepts from the programming language level to a more abstract level using visual formalisms. The basic structural model for objects features a graphical notation for such OO notions as classes and instances, relationships and roles, and aggregation and inheritance. As to system behavior, there are two aspects that have to be modeled, the intra-object behavior which describes the way each one of the instances behaves, and the inter-object behavior which describes the interaction between objects in different possible scenarios of the system. As for the first aspect, most object-oriented modeling approaches adopted the statecharts language [1]. Each class is associated with a statechart that describes the behavior of the class instances. As for the second aspect, the most widely used language is message sequence charts (MSCs), adopted long ago by the International Telecommunication Union. MSCs is a visual language used to describe possible scenarios of a system behavior. In this language, objects are drawn as vertical lines and the communication between these objects is denoted by messages (horizontal lines going from the sending object to the receiving one). Messages in the language of MSCs may describe a wide variety of ‘real’ communications, such as actual messages sent on communication lines between computers, exchanging information using shared memory on a single machine, or even calling functions of one object by another one. Use cases were introduced in order to model the system by identifying the different observable behaviors and interactions of the system with the user.

In 1997 the Object Management Group (OMG) adopted the standard of UML (Unified Modeling Language). This standard encapsulates most of the ideas and notions mentioned above and brings them together as a single worldwide accepted standard. According to most UML-based methodologies for system development, the user first specifies the system's use cases. Then, the implementation of each use case is described using sequence diagrams (the UML name for MSCs). In a later modeling step, the behavior of each object is described by an associated statechart. Finally, each object is implemented as code in a specific programming language. Thus, for example, a use case may specify generally that “a client draws cash in an Automatic Teller Machine (ATM)”. This generalized observable behavior is described in a sequence of diagrams referring specifically to the various sequence of operations that constitute the use case of drawing cash. Thus, for example, a sequence diagram describes the step of feeding-in the client PIN and specifies a different treatment for (i) correct PIN or (ii) in-correct PIN (the latter allows, e.g. two additional retries). A specific sequence diagram is further provided for drawing cash within the client's authorized credit, or alternatively if the clients attempts to draw an amount which exceeds his/her credit (giving him/her opportunity to draw smaller amount), etc. The process described above of specifying and developing systems can be partially automated (see a general discussion of this in [2]) and there are actually different implementations of some of the process steps. The most advanced automated part of the process is that of code generation from object diagrams and their statecharts, as implemented by two tools: ObjectTime (by ObjectTime Inc.) and Rhapsody (by I-Logix Inc.). In 1999, Damm and Harel provided a rather extensive expansion of the system behavior specification language of MSCs to live sequence charts (LSCs) [3].

LSCs distinguish between scenarios that may happen in the system (existential) from those that treat must happen in it (universal). LSCs can further specify what messages may be accepted (cold) and what messages must (hot). Conditions are also handled with higher importance than in MSCs. Conditions may be cold, meaning that the condition may be true, or hot, meaning it must be true (otherwise the system aborts). Since its expressive power is far greater than that of MSCs, the language of LSCs makes it possible to attempt and transits between the first two modeling steps: LSCs and statecharts. Thus, in a recent paper [4], an algorithm for synthesizing statecharts automatically from LSCs specification is given, thus providing a first-cut treatment of automatically converting LSCs to statecharts. However, the transition from use cases to LSCs (or, for that matter, MSCs or any other language that describes inter-object behavior), is still done manually and is considered an art or a craft, besides requiring a deep knowledge of both the syntax and semantics of LSCs (or other specification languages). Before turning to FIG. 1, there follows a brief overview of system modeling. An indispensable part of any serious modeling approach is a rigorous semantical basis for the model constructed—notably, for the behavioral parts of the model and their connection with the structure. It is this semantics that leads to the possibility of executing models and running actual code generated from them (The code need not necessarily result in software; it could be in a hardware description language, leading to real hardware implementation). Obviously, if it is possible to generate full code, this code would eventually serve as the basis for the final implementation. Some current tools, like Statemate and Rhapsody from I-Logix, Inc., or Rose RealTime from Rational Corp,. are in fact capable of producing quality code, good enough for the implementation of many kinds of reactive systems. And there is no doubt that the techniques for this kind of ‘super-compilation’ from high-level visual formalisms will improve in time. When developing a complex system, it is very important to be able to test and debug the model prior to investing extensively in implementation. Hence the desire for executable models. The basis for testing and debugging by executing the model are the requirements, which, by their very nature, constitute the constraints, desires and hopes concerning the system under development. It would be highly desired that both during development and afterwards that the system does, or will do, what it is intended to do.

The overall system modeling and design life cycle as practiced today is illustrated in FIG. 1, taken from [2]. Solid lines indicate that the used methodologies are automated or close to be, whereas dashed lines indicate methodologies that are not supported by any tools.

### SUMMARY OF THE INVENTION

The invention provides for a method for specifying a system behavior, comprising:

(a) providing a GUI representative of the system's GUI; the system GUI includes objects; the system GUI is associated with data structure describing at least the GUI objects; the method includes performing steps that include the following steps (b) and (c), as many times as required:

(b) playing-in a scenario utilizing the system GUI, the scenario is representative of at least one use case; and

(c) constructing formal system behavior specification that corresponds to the scenario.

The invention further provides for a method for modeling system, comprising:

modeling the system including using the above specifying system behavior steps. Still further, the invention provides for an apparatus for specifying a system behavior comprising:

GUI representation of the system's GUI; the system GUI includes objects; the system GUI is associated with data structure describing at least the GUI objects; the apparatus includes a play-in engine configured to perform at least the following, as many times as required:

playing-in a scenario utilizing the system GUI, the scenario is representative of at least one use case; and constructing formal system behavior specification that corresponds to the scenario.

### BRIEF DESCRIPTION OF THE DRAWINGS

For a better understanding, the invention will now be described by way of example only, with reference to the accompanying drawings, in which:

FIG. 1: illustrates schematically a system modeling and design in accordance with the prior art;

FIG. 2: illustrates schematically a system modeling and design incorporating a Play-in scenarios module in accordance with a preferred embodiment of the invention;

FIGS. 3-14 show twelve consecutive screen layouts illustrating an exemplary playing-in calculator application, in accordance with one embodiment of the invention;

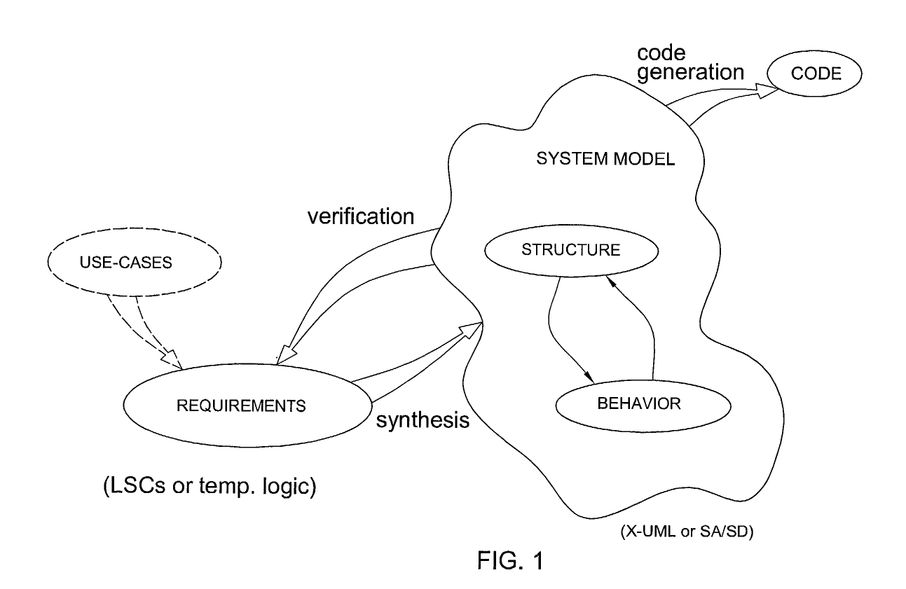

### DETAILED DESCRIPTION OF THE INVENTION

The invention will now be described by way of example only with reference to a preferred embodiment. There is proposed a methodology, supported by an assisting tool—the Play-In Engine, to describe the system's use cases by a formal visual specification language. This language can be any language that is able to capture possible scenarios of system behavior and has sufficient expressive power to describe liveness and safety properties. The tool built translates the system behavior into a set of LSCs. Each LSC describes a scenario of the use case. The main idea of the methodology is to raise the level of abstraction of requirement engineering, enabling engineers who are not familiar with the syntax and semantics of LSCs, or even potential users, to specify the behavioral requirements of the system using a high level mechanism, namely “Play-In”.

Before the user can start with the Play-in procedure, he/she is provided (either by building it on his/her own or receiving it from another source) with a GUI of the system that has no logic built into it. The system provided may contain real graphical objects such as buttons, switches, LEDs, or any other input and output devices. In addition, the GUI system may contain objects that represent real-life objects that are internal to the system, such as CPUs, controllers, or any other components used to construct the system. In the case of systems where there is a meaning to the layout of hidden internal objects (e.g., a board of an electrical system), the user may also be provided with an object or objects in the form of a graphical representation of the layout map. Any combination of the specified objects may be used. Moreover, other objects may be used in addition or in lieu of the above, all as required and appropriate, depending upon the particular application.

Actually, what “Play-In” means is that the user, specifying the behavior of the system, after being provided with the graphical representation, “plays” it by operating the objects. Operating objects includes, for example, one or more of the following: clicking buttons, rotating knobs, turning switches, setting values for displays or any other action used to specify the value of input, output, internal devices or indicators.

The “operating object” action(s) can apply to internal objects and/or to specifying interaction (such as communication) between internal objects or between internal object(s) and one or more input/output object. This interaction between the objects is realized e.g. by sending messages (calling functions) between the objects at the GUI level in an intuitive manner, e.g. by using drag and drop operations.

A typical, yet not exclusive, scenario of using the specified object operation for system behavior specification would be that the user specifies actions (e.g. operating objects such as clicking buttons), and “describes” the system reaction and optionally the condition(s) that may or must hold regarding one or more of the operated objects, using the same techniques (e.g. operating objects—such as displaying the so clicked value on the display and storing the so displayed value for future use). The objects operated in the system reaction mode may be the same, different or partially overlapping to those of the user action mode, depending upon the particular application. This procedure may be repeated as many times as required to accomplish the entire playing-in scenario. The system will continuously, on the fly, construct formal system behavior specification (e.g. in the form of sets of LSCs) from these play-in actions. To make this possible, there is provided in accordance with a preferred embodiment a “Play-in Engine” which will query the application provided by the user, and will interact with it in order to manipulate the information entered by the user, thus learning the desired behavior of the application, and build the appropriate LSCs automatically. Preferably, the application's state during the play-in operation is reflected in the GUI application. For example, consider an output object that is being operated (say, a light indicator that is turned on), the result is reflected in the system GUI. (i.e. the light indicator is portrayed in its “turn on” state).

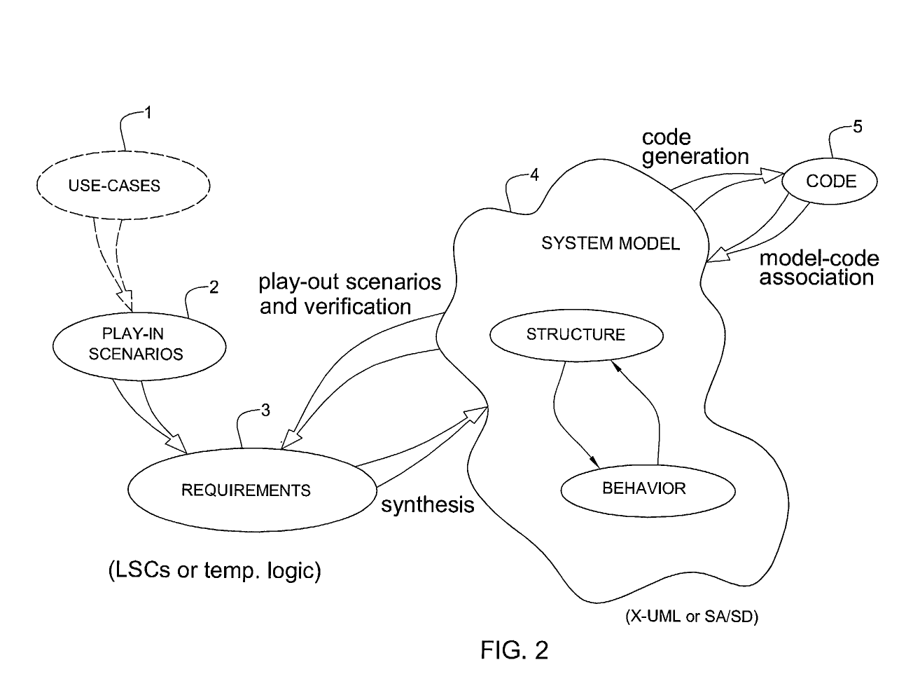

The location of the Play-in scenario proposed methodology in the overall process of system modeling and design in accordance with a preferred embodiment is shown in 2 in FIG. 2. Note that the solid line connecting this ellipse to 3 is due to the proposed Play-In Engine. 1 stands for the high level representation of the use case. 4 is the system model device and 5 is the code implementation thereof.

By a preferred non-limiting embodiment, the Play-In Engine, will handle the following main subjects:

Querying and Activating the Application

In accordance with a preferred embodiment, the user may be provided with several GUI applications (which implement a pre-defined interface required by the engine) and select them from the Play-In Engine. The engine learns the objects defined in the application, and their types, and is able to show and hide the GUI automatically or on user demand, and activate its elements, by setting their values, highlighting them and querying them for their present values. If desired, the play-in engine can support more than one GUI simultaneously, enabling thus to implement more than one application. During the playing-in process the engine uses data structure that stored the relevant data (e.g. representation of the objects, etc.)

Defining Use Cases

In accordance with a preferred embodiment, the user will be able to define any number of use cases. Here, the connection (and tractability) between use cases and their implementation is given a far more rigorous basis than today. In current known methodologies, a domain expert writes a use case description in an informal language (or any similar format) and then has the system engineers describe its implementation formally using sequence diagrams. In the proposed methodology, abstract (yet formal) sequence diagrams are created automatically while the domain expert “plays in” the functionality of the system. The system engineers then continue from the same scenarios by adding objects and refining the system design incrementally.

Defining LSCs

It should be noted, generally, that for convenience, LSC is used as an exemplary formal system behavior specification language. The invention is by no means bound by this example.

In accordance with a preferred embodiment, the user will be able to cause automatic creation of sets of LSCs and (symbolically) connect them to use cases. The Play-In Engine provides a friendly environment to fix the type (existential or universal, called cold or hot in [3]) of messages, locations and conditions. The user will define conditions by operating objects as described before, and graphically determining the values of each object. The Play-In Engine will support common used types like numbers, colors, strings, buttons etc., in a more sophisticated way, thus enabling more advanced interfaces for controlling them. The user will cause construction of the LSCs by playing the GUI provided. The engine will be notified of the events and will simultaneously generate the desired LSC on its own. It should be further noted that, preferably, the reactions of the system will be reflected in the system GUI by graphically changing the values and states of objects in it (to thereby the application state).

Internal Objects

In accordance with a preferred embodiment, LSCs are also used to describe the interaction between internal (non-GUI) objects. The presented methodology handles these interactions, that includes sending messages to other objects and calling functions of them. The interaction between internal objects will be specified using preferably an intuitive graphical layout such as an object map (either defined or actually provided to or by the user) of the relevant objects. The user can specify actions by operating internal objects, e.g. sending messages between these objects at the graphical level in an intuitive manner, such as dragging arrows from the sending object to the receiving one. These interactions may and will usually be interlaced with GUI interactions in a single LSC. At the start of the process of specifying a system, the user does not usually know which are all the objects that will constitute the system. The Play-In Engine will make it possible to declare new objects and new operations on the fly.

Object Connection Rules

In accordance with a preferred embodiment, many reactive and interactive systems have output components that display values reflecting the current state of the system. An example of such a component is the display of a pocket calculator. In these cases, a common LSC would contain arrows depicting the immediate reaction of the output object to a user action (e.g., the user pressed ‘3’ and the display shows ‘3’). Since when specifying system behavior these reactions are not defined, the user should explicitly indicate the change in the output value each time. The Play-In Engine supplies an environment where the user may define connection rules that will be applied automatically whenever one event should trigger another one automatically. Defining connection rules is done in a rather intuitive manner by clicking the source and the target object and connecting them with one of several pre defined functions. These functions may be constant functions (e.g., when the user clicks the ‘Clr’ button, the display should always display ‘0’) or other functions provided by the creator of the GUI application. The second type of functions may contain knowledge of the business logic from the application domain (e.g., when the user clicks a digit, the display is updated to show a new value which is computed by multiplying its current value by 10 and adding the value of the last digit clicked).

The Play-In Engine stores all the connection rules, defined by the user, in a table, and whenever a relevant event occurs, it searches for an applicable rule. If such a rule is found, the engine generates the reaction specified in the rule, as if the user has specified it manually.

Generalization and Random

Loops

While playing in the scenarios of a system, the automatically constructed LSCs are very specific, containing a small number of cases (e.g., in the pocket calculator, the user will describe a scenario where 7+9 are pressed and 16 is displayed at the end). “Play In Scenario” is indeed meant to be a friendly and intuitive methodology for describing the behavior of the system, but more importantly, it should have an expressive power that suffices to describe real systems.

Accordingly, the Play-In Engine supplies friendly mechanisms to let the user indicate that some parts of an LSC are repeated in a loop for a specified or a random number of times. Moreover, the Play-In Engine enables defining exact sections and symbolic sections. In an exact section, the events will be repeated exactly as specified. In a symbolic section, the Play-In Engine may decide on new random input values (of the same kind as the original) for each occurrence of a message or an event. For example, the user may play in a scenario where he/she specifies that 9+7=16. Using a symbolic section, this can be shown as “X1”+“X2”=“X1+X2”, thus giving the scenario a more general meaning.

Chart Tracing

The process that has been described above with reference to a preferred embodiment is focused on visualizing the process of system behavior specification and automatic LSC construction. In accordance with a preferred embodiment, at the end of the process, the user may check his/her work by tracing scenarios that were specified. The tracing of the specified scenarios will show the progress of the system on the charts and will also activate the GUI as if a user were playing it.

In the presence of generalization and random loops, as mentioned above, the possible runs of the system are not simply different orders of the same input, but can include totally different runs with random messages being sent and received.

Play Out Scenario

In accordance with a preferred embodiment, there is provided the feature that enables playing-out a scenario. After specifying a part of the system behavior, or all of it, the user may start working with the GUI application as if it was an operational application. The user will operate the objects as described before and the Play-In Engine will follow the user actions and will make the application react to these actions according to the previously defined specification. Note that by doing so, the user actually tests the behavior of the specified system before implementing it and even before designing the objects that the system is built of.

Programming Tools and Technologies

As describe above, in accordance with one embodiment the Play-In Engine interacts with different a priori unknown system GUIs. In accordance with a preferred embodiment, there is a need for a technology that supports programming to an interface and runtime binding. Supporting these two properties means that two interfaces can be defined: one that will be implemented by the engine and will be known to the GUI-application developers, and another that the GUI-application must support. Thus, the Play-In Engine can be run with systems developed later without having to be linked to them. For example, a technology that is used to this end is Microsoft's COM (Component Object Model), even though it could be developed in any other such environment such as, e.g. Java.

Rapid Prototype and Simulation Tools

Before building a new system, one usually builds a prototype or a mockup of the system to be built. The are several products that enable engineers to avoid building a real hardware mockup and instead to build a software prototype. Since the proposed product is designed to work with interfaces, users may write their GUI in any language they prefer, and even use a commercial prototyping tool. Put differently, third party utilities, such as Altia-Design™ commercially available from Altia Inc. may be utilized for building GUI of interest which is capable of communicating with the Play-in engine of the invention.

It is important to notice that even though the target specification language that the Play-In Engine generates is the language of LSCs, the ideas and methodology are valid for any similar language (that serves for formal system behavior specification) that can express liveness and safety properties of system behavior. The most widespread languages used to describe behavior or requirements about system behavior are:

Temporal Logic (several variants, such as CTL, LTL, CTL*)—a language of formulas using time quantifiers like Next, Always, Eventually, Until, etc.

MSCs, or UML sequence diagrams—a subset of LSCs that concentrates on the existential aspects of sequences (what may happen and not what must).

Symbolic Timing Diagrams—used mainly in the world of communication systems but may be used in other systems as well. Behavior is described as a set of changes in output values (ports) with respect to changes in input values. Timing constraints may be defined between events.

Timed Buchi Automata—finite automata on finite and infinite word that capture the system's possible states as states in the automaton, and possible events as transitions. Each automaton may be associated with a set of clocks, and constraints about these clocks may be defined over the automaton's transitions.

Anyone versed in the art should notice that the same principles used in the proposed methodology apply not only to LSCs, but also to any of the above languages (that are provided by way of example only); either in a straightforward manner or by format translations.

Likewise, the invention is by no means not bound by the specific features of Querying and activating applications; Defining Use cases; Defining LSCs; handling internal objects; Object connection rules; Generalization and Random loops; Chart tracing; Playing out scenarios; and Rapid prototype and simulation tools. Whether or not to use any of the specified features and modules depend upon the particular application. Moreover any of the specified features and modules may be modified, depending upon the particular application and/or other module may be added all as required and appropriate.

In the following, there is given a non-limiting example of the interaction between the user and the Play-In Engine. The example is given as a set of figures showing the user's actions and the resulting diagrams and system reactions. In this example, the user is provided with a GUI of a pocket calculator, which he/she is about to play on. The example is “teaching” the application how numbers are added (the summing of the numbers stands for an exemplary use case). The user of the Play-In Engine, who designs the system is referred to as the ‘designer’ and the end user of the system to be built is referred to as the ‘user’ (the one indicated in the LSC as the actor). Before turning to the example it should be noted that according to hitherto known techniques a designer would phrase in natural language the various procedures that constitute the above use case (adding of numbers). For example, such free text description may include:

i) Press Clr and Clear the display; (ii) key-in a first digit then (iii) key-in another digit ad continue in a loop fashion; (iii) apply a rule which will display the so keyed digits as a number on the display; (iv) Then click an operator (“+”) and in response store the so displayed first number in a variable. (v) Then, clear the display; (vi) repeat the procedure for the second number and store the so clicked second number if desired, repeat this procedure for additional numbers); (vii) await clicking of “=” and apply the “+” operator on the first and second (and others, if any) stored numbers. (ix) clear the display and display the Sum result on the screen.

This free, informal, description is then processed “manually” by designers who will manually construct corresponding LSC sequence charts. In the following, an alternative “playing-in” procedure in accordance with a specific embodiment of the invention is exemplified, obviating, thus the burdensome hitherto known manual procedure. Moreover, whereas in accordance with the invention the playing-in procedure is automatically reduced to LSC charts in an accurate fashion, the counterpart (burdensome) manual procedure in accordance with the prior art strongly depends on the skills of the designer (which naturally vary from one individual to the other) and is therefore inherently error prone.

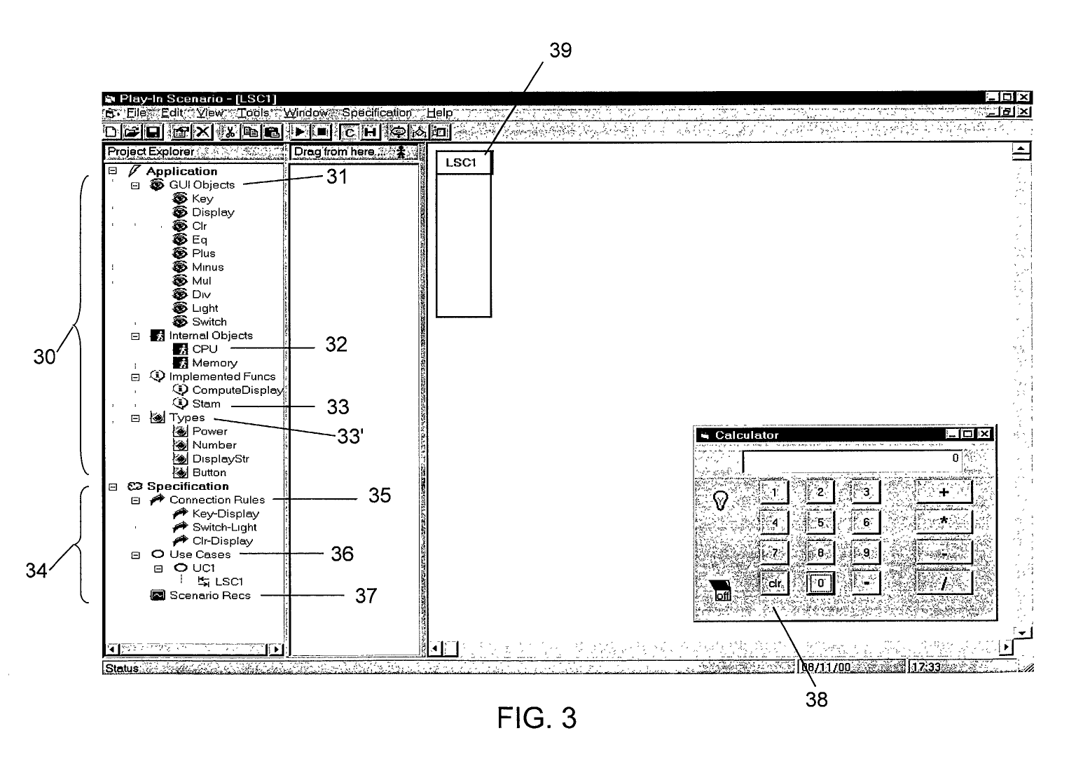

Step 1: Initialization (Described with Reference to FIG. 3)

Here is explained the initial setting and the main elements involved in the specification process. The environment supplied by the Play-In Engine is shown in FIG. 3. Following is a description of each of the elements

The Application Section (30)

This section contains the elements defined in the application. The Play-In Engine queries the application for this information and displays it in a tree format. This information contains:

The GUI objects defined in the application (e.g., Key, Display, Switch, etc.) (31)

The internal objects defined a priori in the application (in this case there are two, Memory and CPU) (32)

A list of functions implemented by the application. These functions are written by the designer to help the user specify more complicated behaviors (e.g., ComputeDisplay computes the value of the display after each number click by multiplying the value of the display by 10 and adding the key). (33)

The types upon which the objects in the application may be based (e.g., Power, Number, etc.) (33′)

The Specification Section (34)

This section contains the elements specified by the user.

Connection Rules, used to help the user with connecting parts of the Play-in, thus alleviating the specification of several cases, such as specifying that every time the CLR key is pressed the Display should show 0. (35)

Use cases and LSCs. This part is the main one in the specification, and it consists of use cases defined by the user and the LSCs implementing them. (36)

Scenario Recordings. This part contains recordings of the user action only. It is for future use and will not be discussed in this example. (37)

The GUI Application (38)

This GUI application (in this case, calculator) was created by the user.

The LSC Diagram (39)

This part contains the Live Sequence Charts that are constructed by the Play-In Engine during play-in. Notice that in FIG. 3 the LSC is empty.

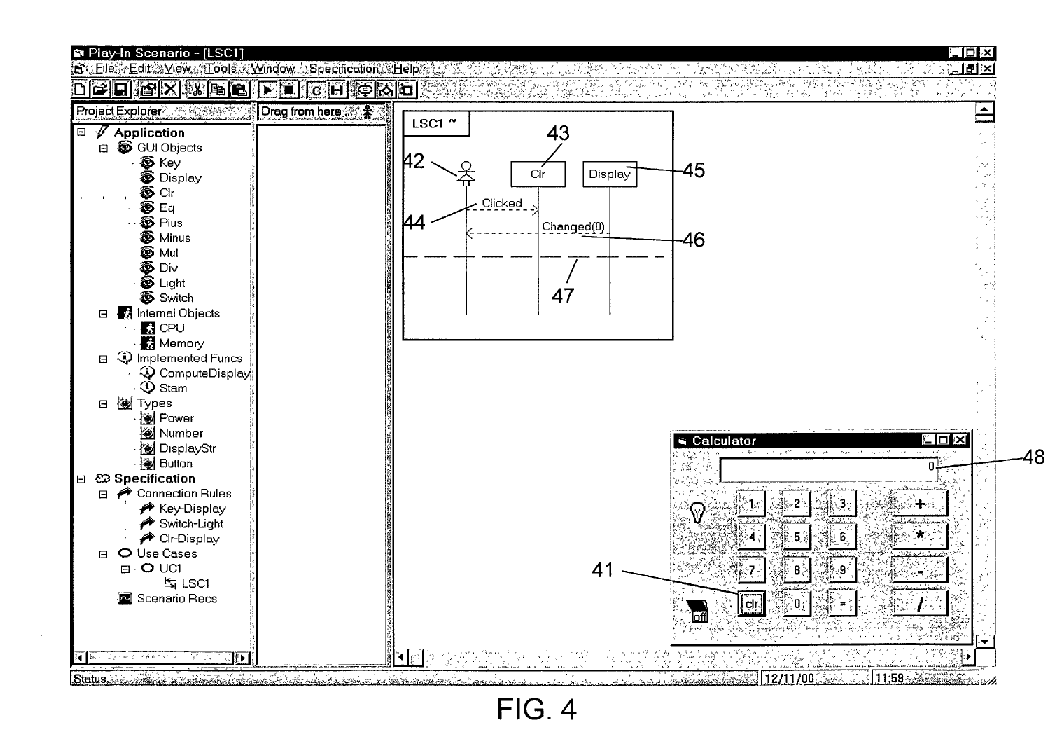

Step 2: (Described with Reference to FIG. 4)

Designer Action

Operate the ‘CLR’ (41) button by clicking it on the calculator.

System Reaction

The Play-In Engine is notified about that event, adds the actor (42) and the CLR instances (43) to the LSC and connects them by an appropriate message (clicked (44)). The engine then seeks an applicable connection rule and finds that the rule Clr-Display dictates that whenever CLR is clicked, the display should change to 0 (see detailed discussion about the rules above). Note that this rule does not replace an explicit specification of the calculator behavior using LSCs, but is rather an assisting tool for the designer in routine and monotonic actions. The engine adds the Display instance (45) to the LSC and generates a message indicating that the display changes to 0 (46). The dashed horizontal line (47) is a graphical cursor indicating where the next message will be located. The engine calls the application which preferably should reflect the current state of the application. By this particular example, the display should show ‘0’ (48) in response to clicking Clr.

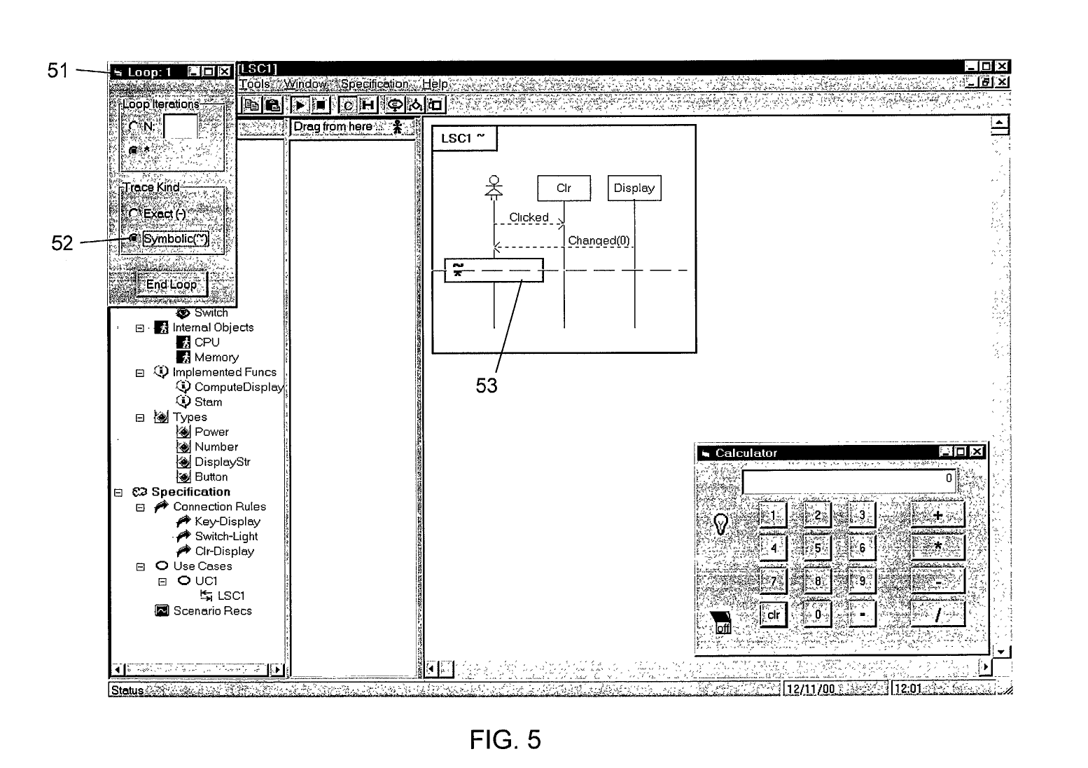

Step 3: (Described with Reference to FIG. 5)

Designer Action

In this step, the designer wishes to specify that the user may click calculator keys several times, and the display should be updated accordingly. To achieve this, the designer clicks the ‘Loop’ button (placed on the tool bar) and a “Loop Assistant” (51) opens up. Since the user is allowed to click any key in the keypad inside the loop and not a specific (“exact”) key, the designer clicks the ‘symbolic’ option (52) in the loop assistant.

System Reaction

After clicking the ‘Loop’ button, the system opens the loop assistant and indicates graphically on the chart that a loop is being specified (53). Note that the cursor indicates that the following messages will be located inside the currently specified loop. The system indicates in the chart whether the loop is exact or symbolic and how many times the loop should run. In this case the loop is symbolic and the number of times is unbounded, denoted by *. Note that the latter specific example illustrates the capability to use control constructs as a part of operating objects to realize “do while”, “if then else” statements etc. In response, appropriate LSC flow control constructs are constructed.

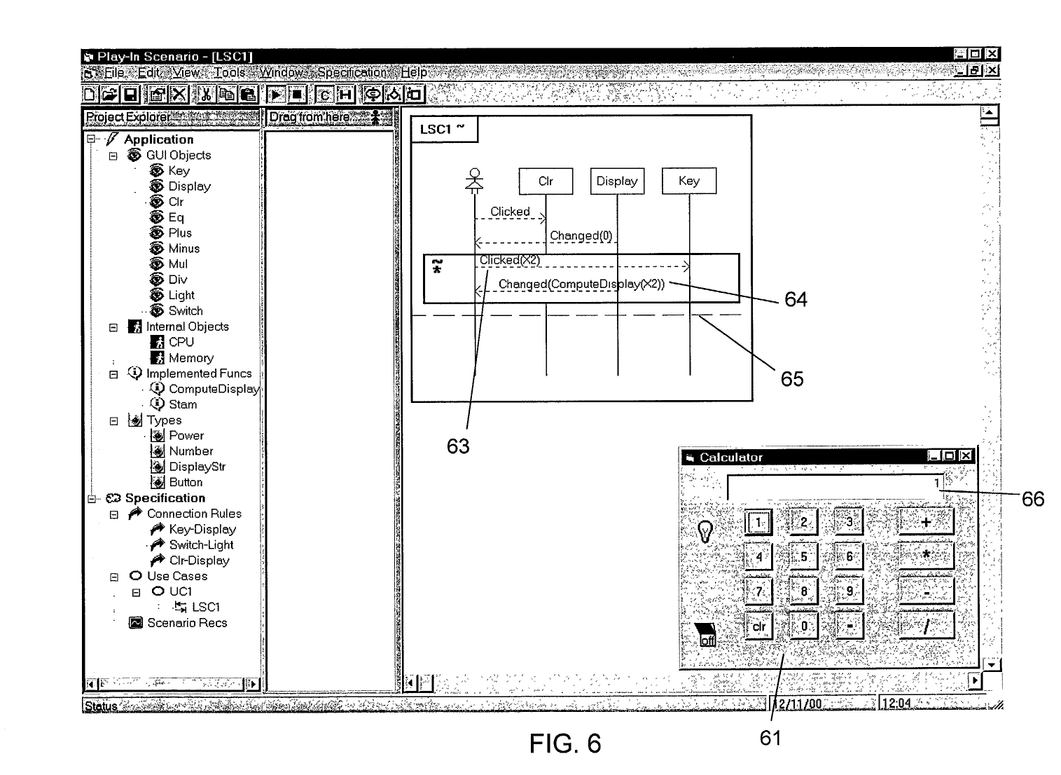

Step 4: (Described with Reference to FIG. 6)

Designer Action

The designer clicks one of the keys (0-9) (61) and then clicks the “End Loop” button in the loop assistant.

System Reaction

After clicking the key, the system adds a message indicating that the key was clicked (63). It, then looks for an applicable connection rule (see detailed discussion above) and finds that the rule Key-Display dictates that after a key is clicked, the display should be updated according to a designer supplied function named “ComputeDisplay”. In an exact mode, what the engine would do is call the application to compute the value of the function applied to the key clicked. In the symbolic mode, the current value has no meaning and what the system shows is that the function should be applied to the key just clicked (indicated using an arbitrary symbol, in this case X2-(64)). After the designer clicks the “End Loop” button, the system removes the highlight from the loop and indicates (by appropriate line 65) that the next element will be outside the loop. As specified above, the application should visually reflect the state of the application and accordingly, assuming that the number ‘1’ was clicked the play-in engine calls the application in order to display the digit ‘1’ (66) and the appropriate message is added (64).

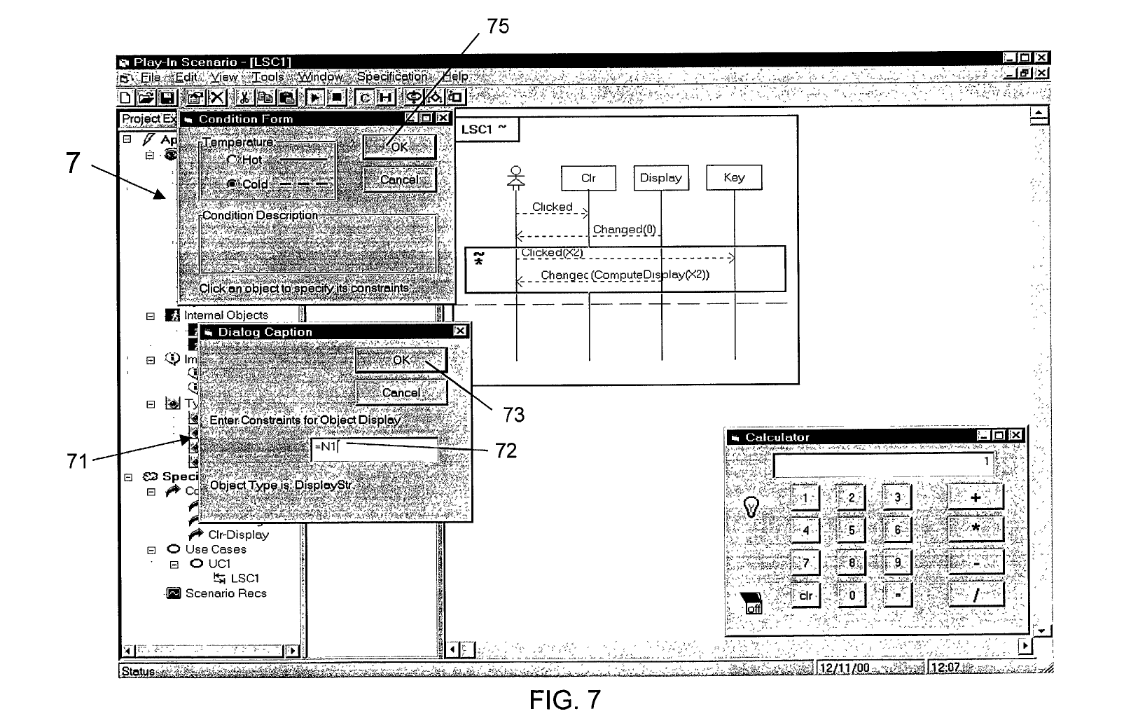

Step 5 (Described with Reference to FIG. 7)

Designer Action

The purpose of this step is to “capture” the display contents in a variable in order to utilize it for the calculator operation, say ‘+’. Thus, the contents of the display (i.e. the first number that is entered) will be captured and assigned to a first variable (say N1), and after the designer clicks the operator (say ‘+’) the next number that will be entered will be assigned to a second variable (say N2) and the sum operation will be applied to N1 and N2.

Bearing this in mind, it is first required to assign the contents of the display (i.e. the first number that is entered) to N1. By this specific example this is realized by inserting a condition saying that the number being displayed is assigned to a variable, say N1. The designer clicks the ‘Assertion’ button (in the tool bar) and then clicks the display of the calculator. In response the condition form (74) is opened. Now the user clicks the display of the calculator. In response, a form (71) is opened, and the designer inputs “=N1” (72) (see “system reaction” below).

System Reaction

After clicking the ‘Assertion’ button, a condition form is opened and the engine waits for the designer to click on objects on which he/she would like to specify constraints. After the display is clicked, the engine opens a form where the user can specify the constraints. One can see that the type of the object clicked is displayed on the form.

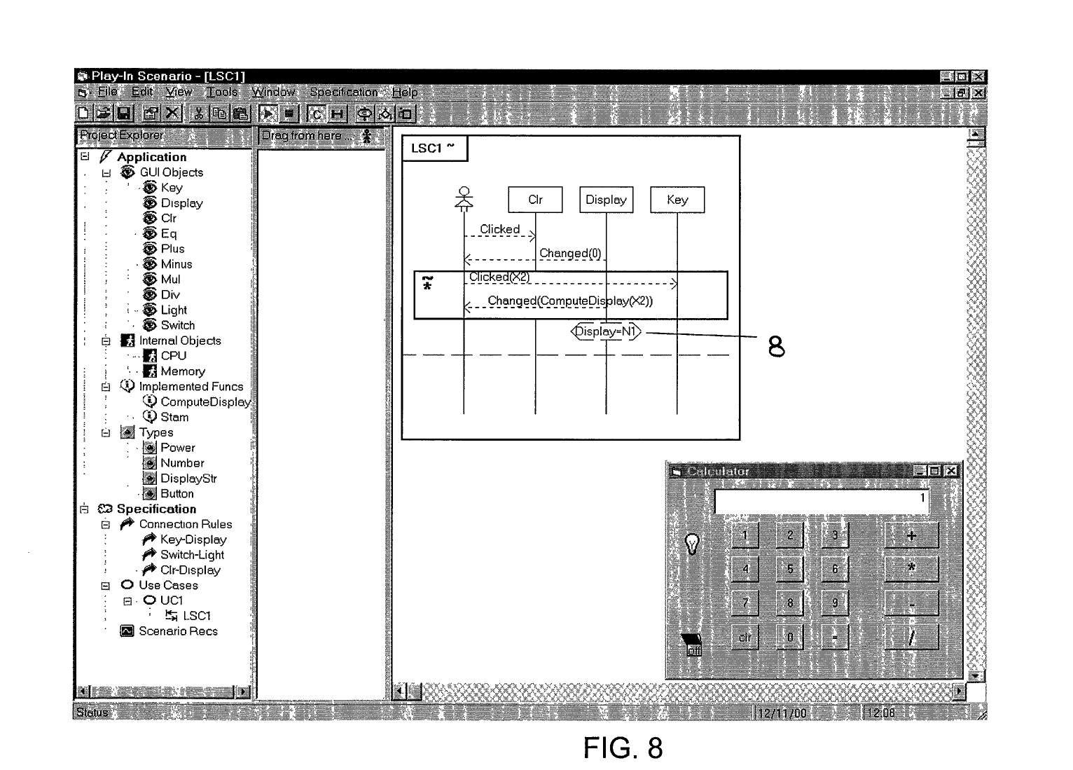

Step 6: Described with Reference to FIG. 8

Designer Action

The designer clicks OK on the condition form (75 in FIG. 7).

System Reaction

The system creates a condition and displays it on the chart (81) according to LSC standards.

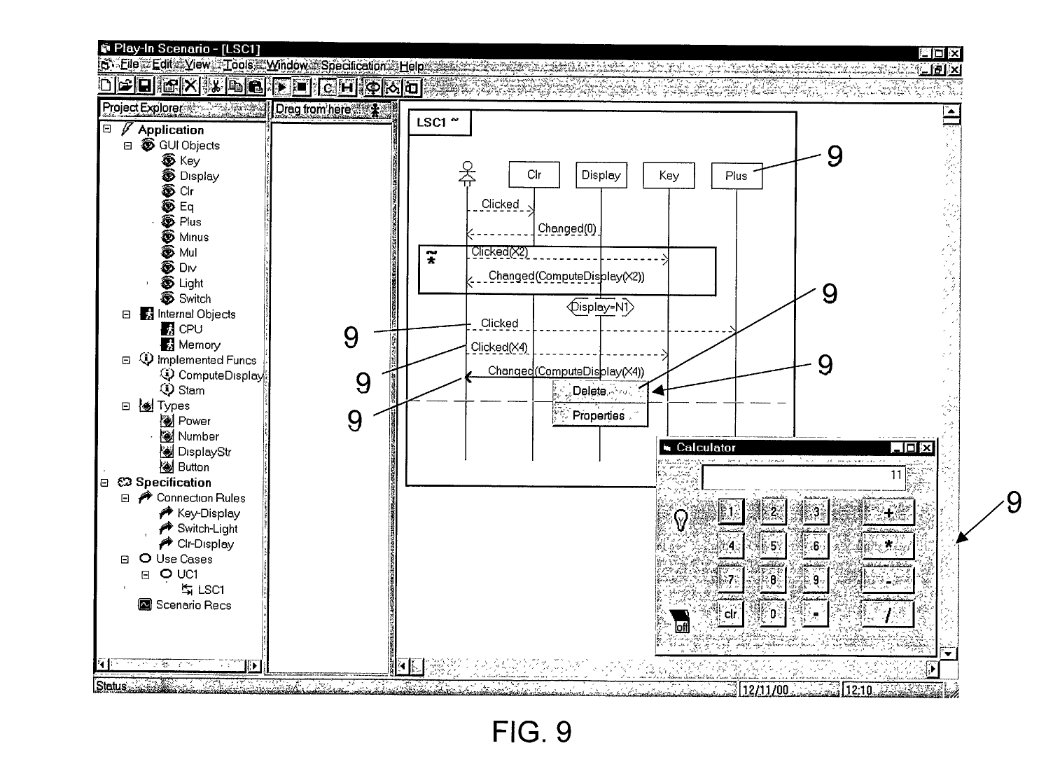

Step 7 (Described with Reference to FIG. 9):

Designer Action

The designer licks the ‘+’ button and then another key (0-9) (91).

System Reaction

The system adds the ‘Plus’ object to the LSC (93) and generates a new message indicating that the user clicked it (92). Had the implementation been as before, the display would have been updated using the automatic rule application after the user clicks the second key (0-9) (see message 94), i.e. the display would comply with the following rule “Second digit+First digit*10”. The latter rule is reflected in message (95).

This behavior is, however, wrong, since the last digit is clicked after the “plus” sign and accordingly a different behavior is expected, i.e. that the first number would be erased and the last clicked digit would be displayed. The next few steps will remedy the faulty behavior as exhibited in message (95). As a first stage the latter automatically generated message must be deleted, and to this end the designer right-clicks the message and a pop-up menu (96) appears enabling the designer to choose the delete option (97) and to delete the message (95).

System Reaction

When the designer right-clicks an element (e.g., message, condition, sub-chart etc.), the system pops up the menu (96) that lets the designer examine the element's properties or delete it (97). After choosing the ‘delete’ option, the system deletes the element (and all sub elements if it is a sub-chart).

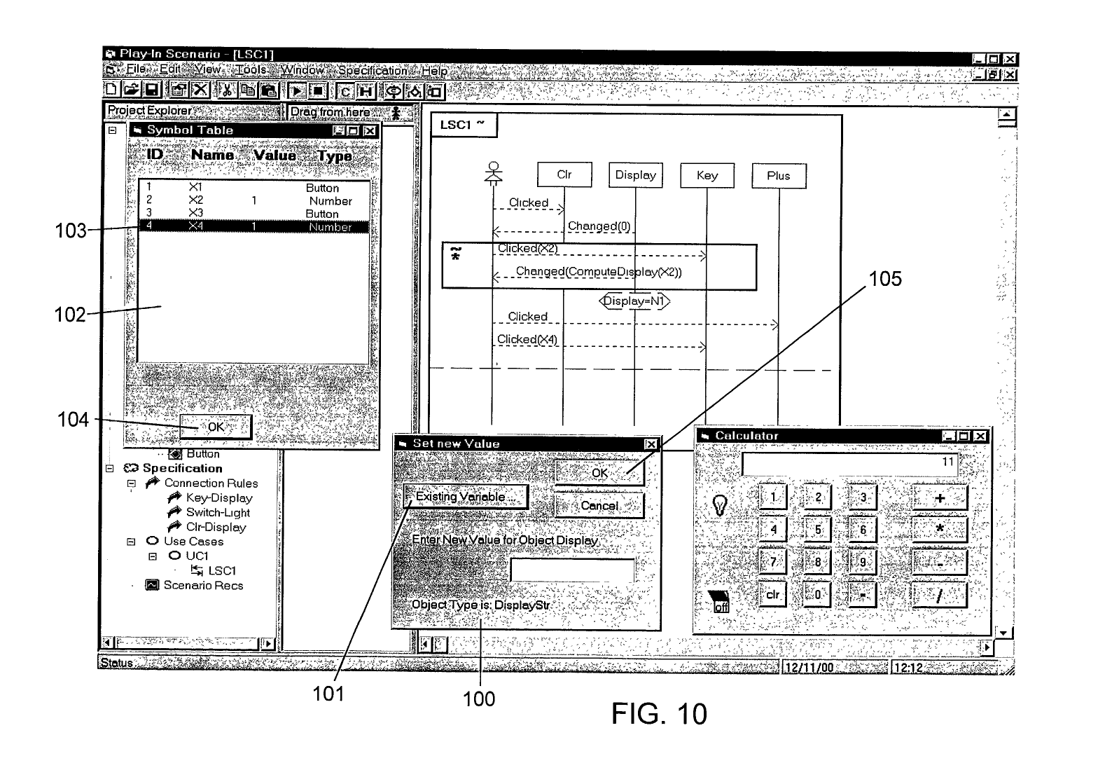

Step 8 (Described with Reference to FIG. 10)

Designer Action

As explained above, the designer wishes to specify that the display should show the value of the last key pressed (i.e. the “second” clicked digit referred to above). To this end, he/she operates the display of the calculator by clicking it.

System Reaction

The system knows (the designer specified it in the system description) that the display is an ‘Out’ object. Thus, after the designer clicks it, a form is opened (100) where a new value can be indicated.

Designer Action

Since the designer wants the value of the display to be the same as the one clicked, he/she chooses “Existing Variable” (101).

System Reaction

The system shows a symbol table (102) from which the designer picks X4 (103) which is the symbol the LSC used to represent the key that was clicked.

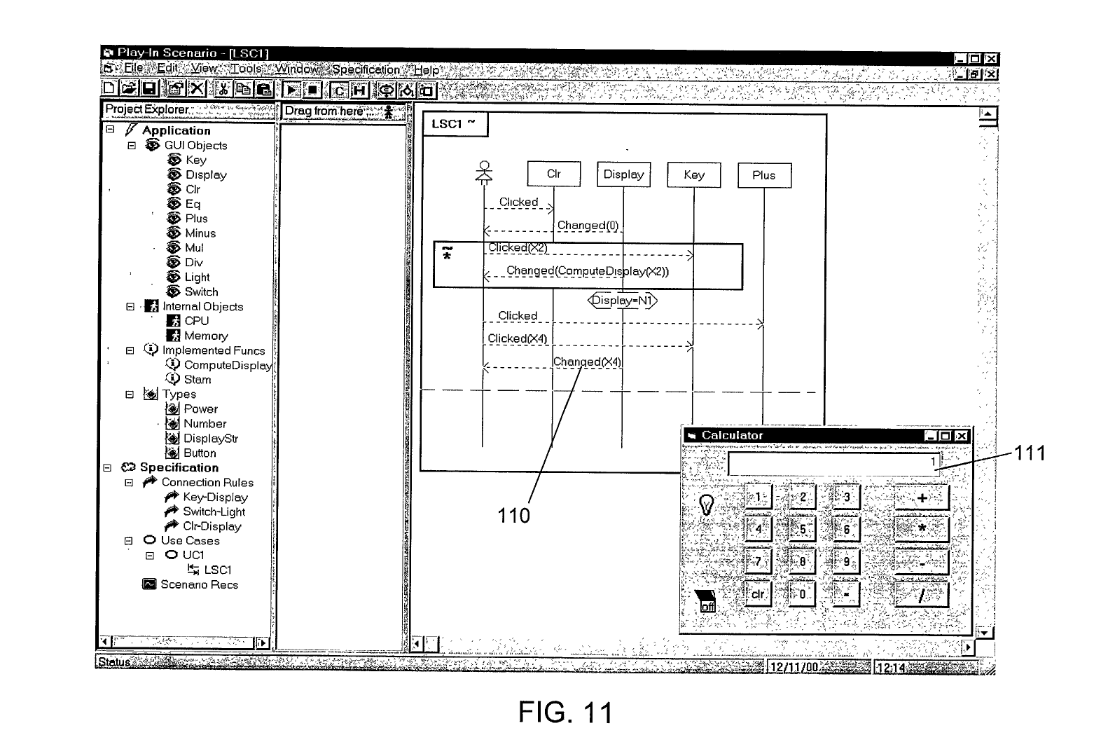

Step 9: (Described with Reference to FIG. 11)

Designer Action

The designer clicks OK on the symbol table and then OK in the ‘New Value’ form (104 and 105 in FIG. 10).

System Reaction

The system shows X4 in the ‘New Value’ form, and when the designer clicks OK on that form, the system generates a message indicating that the display should be changed to the value indicated in the previous message (110 in FIG. 11). The play-in engine now calls the application to visually reflect the state of the application, and more specifically to display the second clicked key ‘1’ (111).

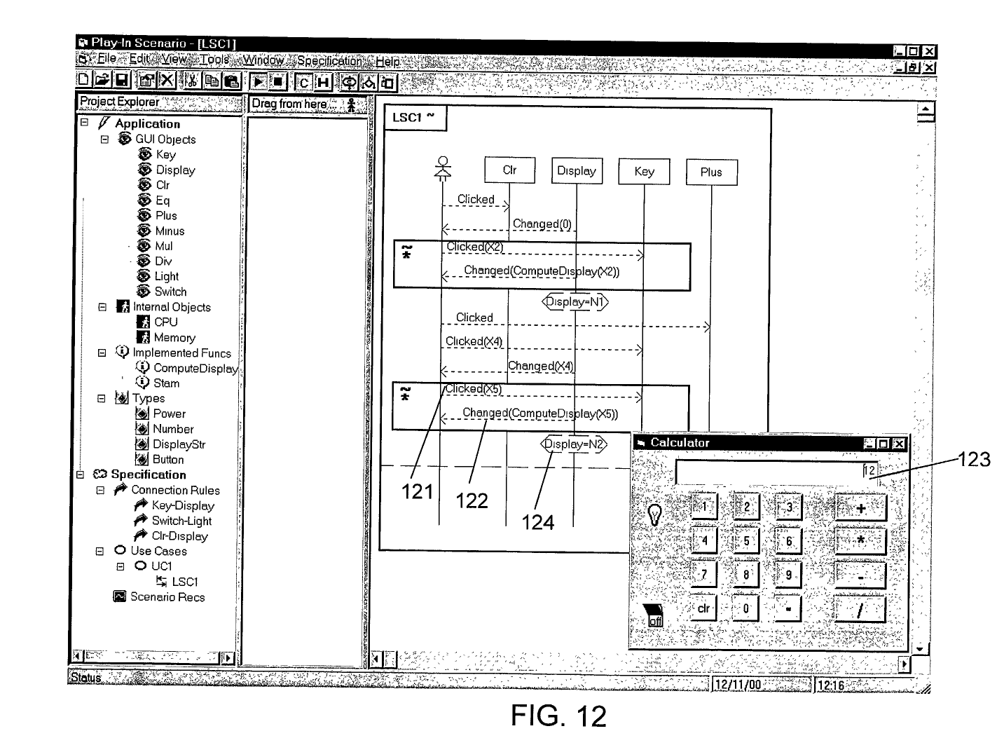

Step 10 (Described with Reference to FIG. 12)

Designer Action and System Reaction

Here, the designer uses another loop to specify that the user may now click several more keys. He/she then inserts a condition that the number displayed is to be equal to N2. The net effect is that a second number is keyed-in (in the example the second number is “12”—composed of first keying the ‘1’ digit and then the ‘2’ digit) and the appropriate messages (121) and (122) are inserted to the LSC chart. Then the display is updated to reflect the second number “12” (123). And lastly, the contents of the display (indicative of the second number) is stored in N2 (condition 124). It is recalled that the first number is already stored in N1. The specified sequence of operations is similar to that described in steps 3-6.

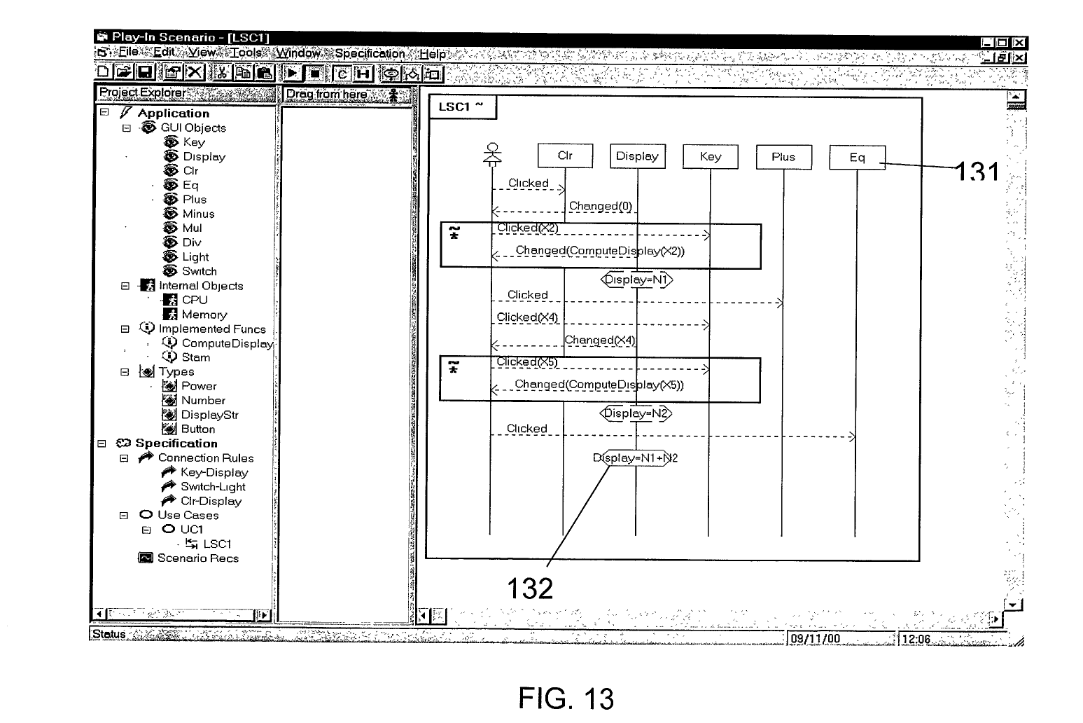

Step 11 (Described with Reference to FIG. 13)

Designer Action

The designer clicks the ‘=’ button on the calculator (not shown) and then inserts a “hot” condition (through the tool bar—not shown) indicating that the display should show the sum of the two numbers. As is known, in the LSC a “hot” condition signifies that the condition must be met, i.e. the numbers must be summed. This ends the play-in scenario.

System Reaction

Same as described in earlier steps. The system lets the designer specify an element as hot through a dialog box, or alternatively, it lets the designer indicate that from some point and on all elements are hot (not shown). Temperatures can be changed after the fact by using the element property dialog. The Equal button object (131) is displayed and the hot condition Display=N1+N2 (132) is portrayed on the LSC chart.

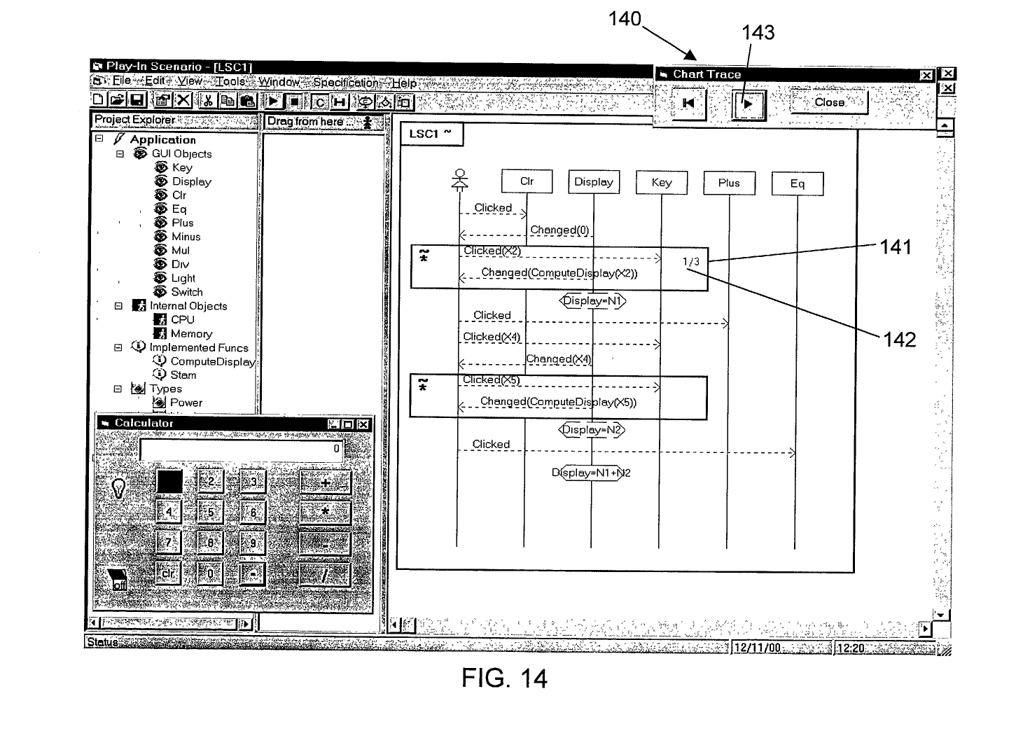

Tracing the Chart (Described with Reference to FIG. 14)

Designer Action

After specifying an LSC the designer may trace it. He/she does so by choosing ‘Trace Chart’ from the menu and then running the steps one by one.

System Reaction

The system opens a “Trace Chart Player” (140). When the designer clicks the ‘next’ button (143), the engine highlights the relevant elements in the chart and the relevant objects in the GUI application. It also changes the values of objects in the GUI application as though a user was playing it. FIG. 14 also shows that additional information is given, such as the current sub-chart , how many iterations a loop should run and what iteration it is currently in. For example, FIG. 14 illustrates that currently the first loop (141) is executes (aimed at inserting the first number) and that it has three iterations (i.e. three digits are keyed-in) and that the current state is the first out-of these three iterations (i.e. the first digit is clicked 142). It should be noted that in the trace mode the number of iterations (by this example 3) in the loop is a priori fed to the system.

Those versed in the art will readily appreciate that the invention is not bound by the specific example above nor by the specific manner of its implementation. Thus, for example, other application GUI and/or LSC than those depicted in FIGS. 3 to 14 may be used. The break down to the steps in the manner described above is not binding. The utilization of rules is one out of many possible variants that can be used. If desired, for convenience drag-and-drop operations may be used. These are only examples and other modifications may be applied, all as required and appropriate depending upon the particular application.

The example of calculator has concentrated on specifying the interaction between the user and the system, and therefore emphasized the operations of GUI objects. Here is a brief description of how interaction with internal objects such as e.g. memory and CPU may be handled. Consider the following non-limiting example. Suppose that the designer wishes to specify that after the ‘+’ key was clicked, the number N1 is sent from the Display to some internal object, say the CPU. The designer may be provided with a graphical layout of the computer motherboard (containing only the elements essential to the specification). Using this layout, the user clicks the Display object on the calculator and drags an arrow from the display object to the CPU box object on the motherboard layout map. When doing so, the play-in engine will open a menu containing all the messages (in this case, methods) that the CPU can handle. The designer then chooses one of these methods (e.g., “Store Number”). By this specific example the operation of the object signifies interaction between the display object and the CPU object where the contents of the display is stored in the CPU memory.

The engine would then add a message, in the LSC, from the Display to the CPU, with the label “Store Number (N1)”. In this way, the user may continue specifying the reaction between GUI objects and internal objects and between internal objects and themselves.

In case no graphical layout is provided to the user (or created by him), the user may simply specify two dimensional coordinates for each internal object, and the Play-In Engine will construct an “Object Map” (being an extension to the system GUI) to serve as a simple graphical layout for that purpose. In the method claims that follow, alphabetic characters or roman symbols used to designate claim steps are provided for convenience only and do not imply any particular order of performing the steps.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The present invention has been described with a certain degree of particularity, but those versed in the art will readily appreciate that various alterations and modifications may be carried out without departing from the scope of the following Claims:

References

[1] Harel, D., “Statecharts: A Visual Formalism for Complex Systems”, Sci. Comput. Prog. 8 (1987), pp. 231-274.

[2] Harel, D., “From Play-In Scenarios To Code: An Achievable Dream”, IEEE Computer, 34:1 (January 2001), pp. 53-60. Early version in Proc. Fund. Appr.. to Soft. Eng., Springer-Verlag, March 2000, pp. 22-34.

[3] Damm, W., and D. Harel, “LSCs: Breathing Life into Message Sequence Charts”, Proc. 3^{rd} IFIP Int. Conf on Formal Methods for Open Object-based Distributed Systems, (P. Ciancarini, A. Fantechi and R. Gorrieri, eds.), Kluwer Academic Publishers, pp. 293-312, 1999.

[4] Harel, D., and H. Kugler, “Synthesizing State-Based Object Systems from LSC Specifications”, 1999, Available as Technical Report MCS99-20, The Weizmann Institute of Science, Rehovot, Israel, http://www.wisdom.weizmann.ac.il/reports.html

1. A method for specifying a system behavior, comprising:
(a) providing a GUI representative of the system's GUI; the system GUI includes objects; the system GUI is associated with data structure describing at least the GUI objects; the method includes performing steps that include the following steps (b) and (c), as many times as required;
(b) playing-in a scenario utilizing the system GUI, the scenario is representative of at least one use case; and
(c) constructing formal system behavior specification that corresponds to the scenario.

2. The method according to claim 1, wherein said step (b) further includes:
operating at least one of said objects in the system GUI.

3. The method according to claim 2, wherein said step further includes:
specifying user action by operating at least one of said objects; and
specifying system reaction by operating at least one of said objects.

4. The method according to claim 2, wherein said step further includes
operating at least one internal object.

5. The method according to claim 3, wherein said step further includes
operating at least one internal object.

6. The method according to claim 2, further comprising the step of: defining at least one control construct and wherein said step (c) includes constructing formal system behavior specification that corresponds to the control construct.

7. The method according to claim 6, wherein said LSC construction step includes creating generalization and random loops.

8. The method according to claim 1, further comprising the step of: reflecting in the system GUI the result of the operation of at least one of said objects.

9. The method according to claim 1, wherein said formal system behavior specification being a Live sequence chart.

10. The method according to claim 1, wherein said formal system behavior specification being Temporal logic language.

11. The method according to claim 1, wherein said formal system behavior specification being Symbolic timing diagrams.

12. The method according to claim 1, wherein said formal system behavior specification being Timed Buchi Automata.

13. The method according to claim 1, further comprising the step of playing out scenarios.

14. The method according to claim 1, further comprising the step of tracing charts.

15. A method for modeling system, comprising:
modeling the system including using the specifying system behavior steps of claim 1.

16. The method according to claim 2, further comprising the step of:
defining at least one condition that may or must hold regarding the system, and wherein said step (c) includes constructing formal system behavior specification that corresponds to the at least one condition.

17. The method according to claim 16, wherein at least one of said conditions includes defining condition regarding one or more of the operated objects.

18. The method according to claim 9, further comprising the step of:
selectively modifying said chart.

19. An apparatus for specifying a system behavior, comprising:
GUI representation of the system's GUI; the system GUI includes objects; the system GUI is associated with data structure describing at least the GUI objects; the apparatus includes a play-in engine configured to perform at least the following, as many times as required:
playing-in a scenario utilizing the system GUI, the scenario is representative of at least one use case; and
constructing formal system behavior specification that corresponds to the scenario.

20. An apparatus of claim 19, for use in with a system modeling device.
